(19) United States
(12) Patent Application Publication
(10) Pub. No.: US 2006/0256685 A1
(43) Pub. Date: Nov. 16, 2006

(54) RECORDING SYSTEM FOR LIGHT-SENSITIVE SHEET

(76) Inventors: Wai William Wang, Kweishan (TW); Meng-Shin Yen, Kweishan (TW); Chung-Ping Chuang, Kweishan (TW); Ta-Yuan Lee, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/382,954

(22) Filed: May 12, 2006

(30) Foreign Application Priority Data
May 13, 2005 (TW) 094115706

(51) Int. Cl. G11B 7/12

(52) U.S. Cl. 369/47.53

(57) ABSTRACT

The present invention relates to a system for recording a datum onto a pixel on a light-sensitive sheet. The main component of the system is a recording unit, which further includes a light-emitting device and at least one light-guiding device. Once the light-emitting device emits a light, the light enters the light-guiding device from an entrance and is transmitted out from an exit. Before the datum is recorded, the recording unit is moved so as to align the exit of the light-guiding device with the pixel. Thereby, the light transmitted out from the exit of the light-guiding device is further projected onto the pixel to record the datum on the pixel.

### BACKGROUND OF THE INVENTION

1. Field of the Invention

The present invention relates generally to a recording system and, more particularly, to a system for recording data, such as images, onto a light-sensitive sheet.

2. Description of the Prior Art

As modern technology continues to develop, users can now easily print their pictures stored in digital formats, such as bitmap or JPEG, on paper through ink-jet printing or laser-jet printing.

Currently, there are a variety of light-sensitive sheets or films that have been developed to form images thereon in response to lights of primary colors (i.e. red, green, and blue); examples of these light-sensitive sheets or films are cycolor paper, dry Ektacolor paper, or other similar mediums. However, the applications of these products are usually restricted due to the need of darkroom processing and associated professional knowledge.

Accordingly, a scope of the invention is to provide a system for recording data, such as images, on a light-sensitive sheet. In particular, the system of the present invention has the advantages of uncomplicated design, easy assembling, and low production cost.

### SUMMARY OF THE INVENTION

According to a first preferred embodiment of the present invention, a system is provided for recording a datum onto a pixel on a light-sensitive sheet. The recording system, according to the invention, includes a controlling/processing unit, a recording unit, and an actuating device. The recording unit includes a light-emitting device and a light-guiding device.

The controlling/processing unit is used for receiving and processing the datum. The controlling/processing unit also controls the actuating device based on the datum and drives the light-emitting device in accordance with the datum. The recording unit is disposed in a way, such that the recording unit faces a side of the light-sensitive sheet where the pixel is formed when the sheet is installed in the system. The light-emitting device is used for emitting a light when driven by the controlling/processing unit. The light-guiding device has an entrance coupled to the light-emitting device and an exit, wherein the light, once emitted by the light-emitting device, enters the light-guiding device from the entrance and is transmitted out from the exit. The actuating device is used for movably carrying the recording unit. The actuating device is controlled by the controlling/processing unit to move the recording unit, such that the exit of the light-guiding device of the recording unit is positioned at a position corresponding to the pixel on the light-sensitive sheet. Thereby, the light transmitted out from the exit of the light-guiding device is further projected onto the pixel to record the datum on the pixel. According to a second preferred embodiment of the invention, a system is provided for recording a datum onto a pixel on a light-sensitive sheet. The pixel is constituted by N color fields. The datum includes values of N colors, each of which corresponds to one of the N color fields where N is a natural number. The recording system, according to the invention, includes a controlling/processing unit, a recording unit, and an actuating device. The recording unit includes a light-emitting device and N light-guiding devices. The controlling/processing unit is used for receiving and processing the datum. The controlling/processing unit also controls the actuating device based on the datum and drives the light-emitting device in accordance with the datum. The recording unit is disposed in a way, such that the recording unit faces a side of the light-sensitive sheet where the pixel is formed when the sheet is installed in the system. The light-emitting device is used for emitting lights of the N colors when driven by the controlling/ processing unit. Each of the N light-guiding devices corresponds to one of the lights of the N colors; each light-guiding device has a respective entrance coupled to the light-emitting device and a respective exit, wherein one of the lights of the N colors, once emitted by the light-emitting device, enters the entrance of the corresponding light-guiding device and is transmitted out from the exit of the corresponding light-guiding device. The actuating device is used for movably carrying the recording unit. The actuating device is controlled by the controlling/processing unit to move the recording unit, such that the exit of one of the N light-guiding devices of the recording unit is positioned at a position corresponding to the corresponding color field of the pixel on the light-sensitive sheet. Thereby, the lights transmitted out from the exits of the light-guiding devices are further projected onto the pixel to record the datum on the pixel. The advantage and spirit of the invention may be understood by the following recitations together with the appended drawings.

### BRIEF DESCRIPTION OF THE APPENDED DRAWINGS

FIG. 1A is a schematic diagram showing the configuration and function devices of a recording system according to a first preferred embodiment of the invention.

FIG. 1B illustrates an embodiment showing a recording unit of the recording system shown in FIG. 1A.

FIG. 2A is a schematic diagram showing the configuration and function devices of a recording system according to a second preferred embodiment of the invention.

FIG. 2B illustrates an embodiment showing the recording unit of the recording system shown in FIG. 2A.

FIG. 2C illustrates another embodiment showing the recording unit of the recording system shown in FIG. 2A.

FIG. 3A depicts a recording head which is configured to arrange a plurality of recording units of the recording system according to the first preferred embodiment of the invention.

FIG. 3B depicts a recording head which is configured to arrange a plurality of recording units of the recording system according to the second preferred embodiment of the invention.

### DETAILED DESCRIPTION OF THE INVENTION

One purpose of the present invention is to provide a system for recording data, such as images, on a light-sensitive sheet. In particular, the recording system of the present invention has the advantages of uncomplicated design and easy assembling. The description of several embodiments according to the invention will be given to explain the features, spirits, benefits, and convenience of the invention.

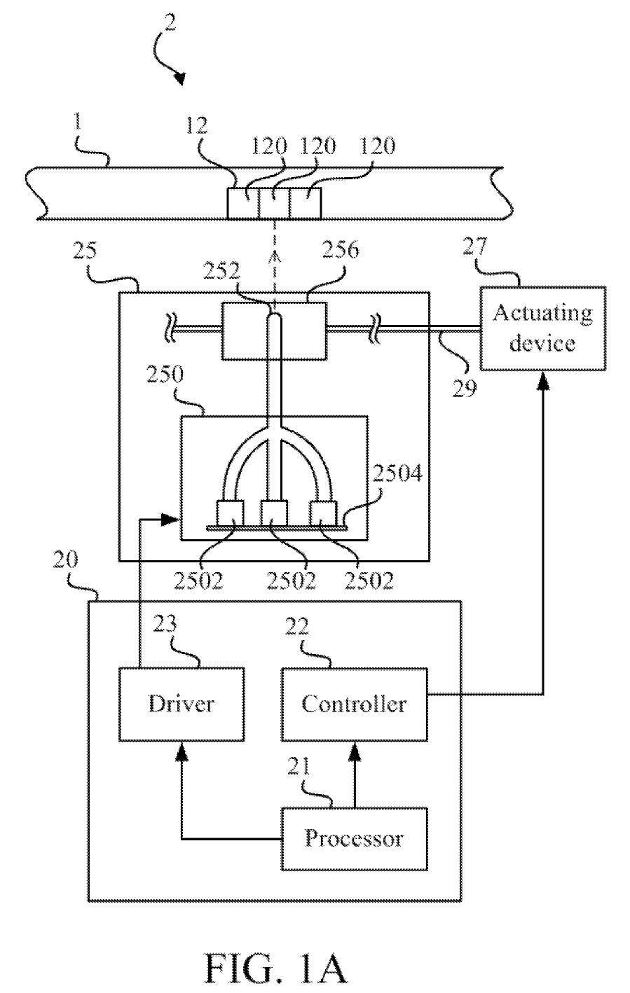

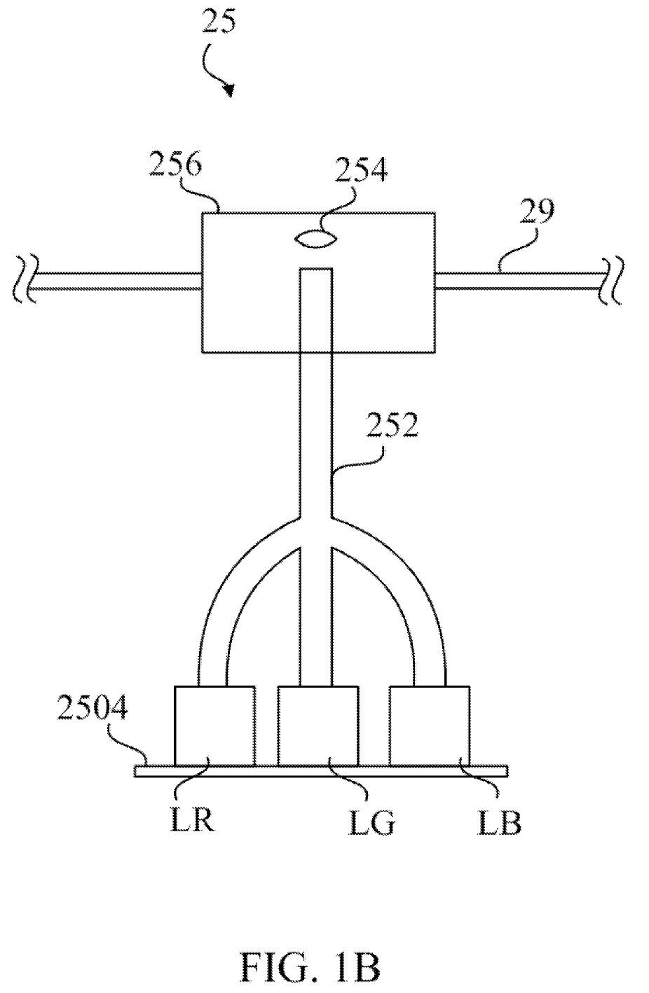

Referring to FIG. 1A, FIG. 1A is a schematic diagram showing the configuration and function devices of a recording system 2 according to a first preferred embodiment of the invention. The recording system 2 shown in FIG. 1A is used for recording a datum onto a pixel 12 on a light-sensitive sheet 1.

The light-sensitive sheet 1 changes its color in response to lights of various colors, such as the three primary colors (i.e. red, green, and blue). In an embodiment, the light-sensitive sheet 1 can be a variety of color papers, such as cycolor paper or dry Ektacolor paper.

As shown in FIG. 1A, the recording system 2 includes a controlling/processing unit 20, a recording unit 25, and an actuating device 27. The controlling/processing unit 20 includes a processor 21, a controller 22, and a driver 23. The processor 21 is used for receiving and processing the datum. The controller 22, which is operated by the processor 21, controls the actuating device based on the datum. The driver 23, which is operated by the processor 21, drives a light-emitting device 250 in accordance with the datum.

Also shown in FIG. 1A, the recording unit 25 includes the light-emitting device 250 and a light-guiding device 252. The recording unit 25 is disposed to face one side of the light-sensitive sheet 1 where the pixel 12 is formed so as to perform data recording. The light-emitting device 250 emits a light with an intensity corresponding to the datum to be recorded when driven by the driver 23. The light-guiding device 252 has an entrance coupled to the light-emitting device 250 and an exit. Once the light is emitted by the light-emitting device 250, it enters the light-guiding device 252 from the entrance and is transmitted out from the exit.

The actuating device 27 is used for movably carrying the recording unit 25. The actuating device 27 is controlled by the controller 22 to move the recording unit 25, such that the exit of the light-guiding device 252 of the recording unit 25 is positioned at a position corresponding to the pixel 12 on the light-sensitive sheet 1. Particularly, the processor 21 determines a position corresponding to the datum to be recorded. Afterwards, the controller 22 controls the actuating device 27 to move the recording unit 25 to the determined position. Thereby, the light transmitted out from the exit of the light-guiding device 252 is further projected onto the pixel 12 to record the datum. In one embodiment, as shown in FIG. 1A, the pixel 12 is constituted by N color fields 120. The datum to be recorded includes values of N colors, each of which corresponds to one of the N color fields 120; N is a natural number. The light-emitting device 250 includes N light sources 2502, each of which is driven to emit one of the lights of the N colors in accordance with the datum. The entrance of the light-guiding device 252 is couple to the N light sources 2502, respectively. Particularly, when one of the lights of the N colors is emitted by the N light sources 2502, the exit of the light-guiding device 252 is positioned at a location opposite to the corresponding color field 120 of the pixel 12 on the sheet 1. In practical applications, the N color values include red, green, and blue color values. The light-guiding device 252 may be made of an optical fiber.

Referring to FIG. 1B, FIG. 1B illustrates an embodiment showing a recording unit 25 of the recording system 2 shown in FIG. 1A. The light-emitting device 250 of the recording unit 25 includes a light source of red LR, a light source of green LG, and a light source of blue LB. The three light sources are coupled to the entrance of an optical fiber 252 by welding or other mechanical devices. During data recording, the three light sources are turned on successively. Particularly, the lights emitted by the light sources have a respective intensity corresponding to the color values of the datum. In one embodiment, the light sources are LED lamps, which may be welded on a control circuit 2504, such as a PCBA (Print Circuit Board Assembly), and is driven by the control circuit 2504 to illuminate a light.

According to the present invention, the recording system 2 projects lights onto a pixel 12 on a light-sensitive sheet 1 to perform data recording. In practical applications, the sizes of the LED lamps are too large with respect to those of pixels 12 on the light-sensitive sheet 1. Therefore, it is necessary to condense the lights emitted from the LED lamps before projecting them onto the pixel 12 of the sheet 1. Currently, it is possible to manufacture optical fibers of tiny aperture diameter. Optical fibers may be utilized to obtain tiny light beams when used as a conducting medium, thus enhancing the resolution of the recording system 2.

In one embodiment, the exit of the optical fiber 252 may be formed as a convex surface to function as a lens for condensing the light transmitted through the optical fiber 252. Alternately, the exit of the optical fiber 252 may also be formed as a flat surface. For the purpose of light-condensing, the recording unit 25 may further include a lens 254, which is disposed in front of the exit of the optical fiber 252, for condensing the light transmitted out of the optical fiber 252 from the exit.

In one embodiment, the light-guiding device 252 is flexible, such as an optical fiber 252, may be arranged in a cartridge 256. In particular, the cartridge 256 is movably mounted in the recording system 1, and operatively coupled to the actuating device 27. For example, a guiding shaft 29 is fixedly disposed in the recording system 2 to mount the cartridge 256 operatively coupled to the actuating device 27, and to enable the cartridge 256 to move linearly along the guiding shaft 29. More in particular, the light-emitting device 250 is fixedly mounted in the recording system 2, and the exit of the flexible light-guiding device 252 is arranged in the cartridge 256. By means of sheet-delivering device, such as rollers or the like, the light-sensitive sheet 1 is moved along a direction perpendicular to the guiding shaft 29. Furthermore, the recording unit 25 sequentially records data onto the light-sensitive sheet 1.

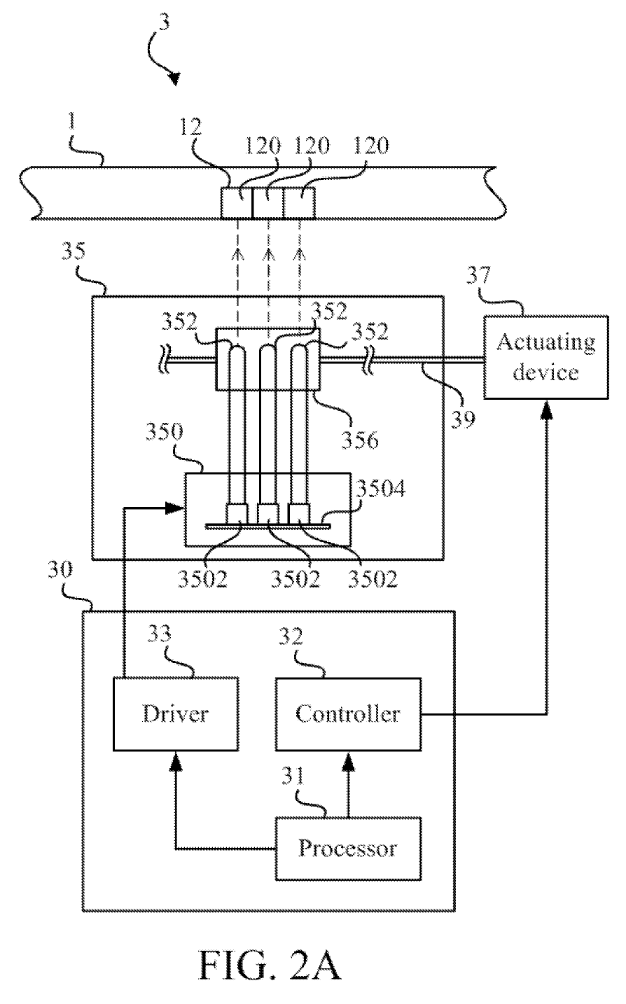

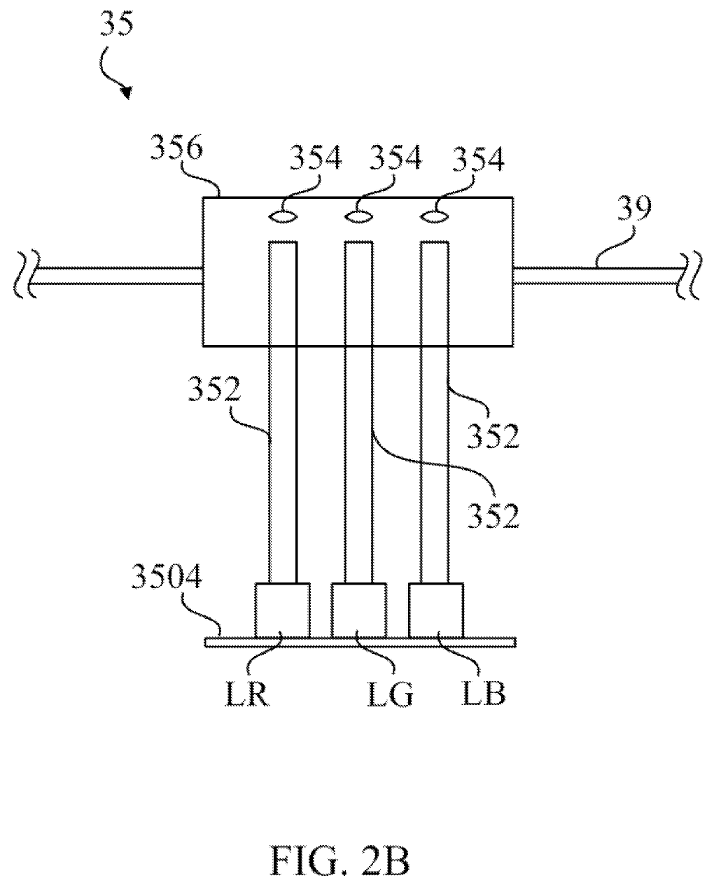

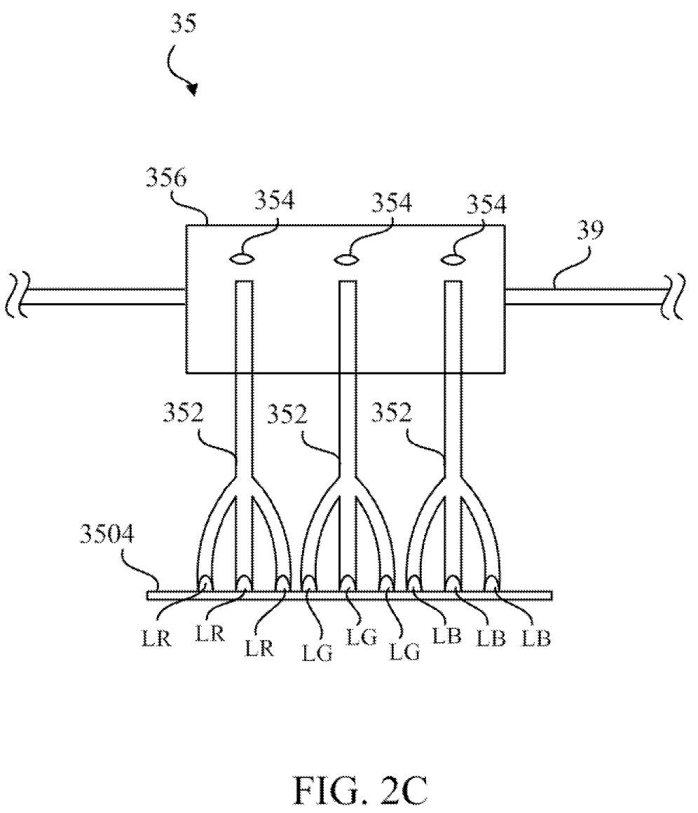

Referring to FIG. 2A, FIG. 2A is a schematic diagram showing the configuration and function devices of a recording system 3 according to a second preferred embodiment of the invention. The recording system 3 shown in FIG. 2A is used for recording a datum onto a pixel 12 on a light-sensitive sheet 1. The pixel 12 is constituted by N color fields 120. The datum includes values of N colors, each of which corresponds to one of the N color fields 120 where N is a natural number. The detailed descriptions about the light-sensitive sheet 1 and related embodiments are the same as the aforementioned discussion and will be omitted here.

As shown in FIG. 2A, the recording system 3 includes a controlling/processing unit 30, a recording unit 35, and an actuating device 37. The controlling/processing unit 30 includes a processor 31, a controller 32, and a driver 33. The processor 31 is used for receiving and processing the datum. The controller 32, which is operated by the processor 31, controls the actuating device 37 based on the datum. The driver 33, which is operated by the processor 31, drives a light-emitting device 350 in accordance with the datum.

Also shown in FIG. 2A, the recording unit 35 includes the light-emitting device 350 and N light-guiding device 352. The recording unit 35 is disposed to face one side of the sheet 1 where the pixel 12 is formed, so as to perform data recording. The light-emitting device 350 emits one of the lights of the N colors with an intensity corresponding to the datum to be recorded when driven by the driver 33. Each of the N light-guiding devices 352 corresponds to one of the lights of the N colors. Besides, each of the N light-guiding devices 352 has a respective entrance coupled to the light-emitting device 350 and a respective exit. Once one of the lights of the N colors is emitted by the light-emitting device 350, it enters the corresponding light-guiding device 352 from its entrance and is transmitted out from the exit.

The actuating device 37 is used for movably carrying the recording unit 35. The actuating device 37 is controlled by the controller 32 to move the recording unit 35, such that the exit of one of the N light-guiding devices 352 of the recording unit 35 is positioned at a position corresponding to the corresponding color field of the pixel 12 on the sheet 1. Particularly, the N light-guiding devices 352 are arranged in the recording unit 35 in accordance with the way that the N color fields constitute the pixel 12. The processor 31 determines a position corresponding to the datum to be recorded. Afterwards, the controller 32 controls the actuating device 37 to move the recording unit 35 to the determined position. Thereby, the lights transmitted out from the exit of the light-guiding devices 352 are further projected onto the pixel 12 to record the datum. In one embodiment, the light-emitting device 350 includes a plurality of light sources 3502. At least one of the light sources 3502 corresponds to one of the lights of the N colors and is driven to emit the corresponding light in accordance with the datum. The entrance of each of light-guiding devices 352 is coupled to the corresponding light source 3502 respectively. In practical applications, the N color values include red, green, and blue color values. The light-guiding devices 352 may be made of an optical fiber.

Please refer to FIGS. 2B and 2C, which illustrate a respective embodiment showing the recording unit 35 of the recording system 3 shown in FIG. 2A. As shown in FIG. 2B, the light-emitting device 350 of the recording unit 35 may include a single light source of red LR, a single light source of green LG, and a single light source of blue LB. Alternately, the light-emitting device 350 may also, as shown in FIG. 2C, include more than one light source of red LR, more than one light source of green LG, and more than one light source of blue LB. The purpose of multiple light-sources is to increase the maximum intensity of color lights provided by the light-emitting device 350. Light sources of different colors are coupled to the entrances of corresponding optical fibers 352 by welding or other mechanical devices. During data recording, light sources of different colors are turned on successively. Particularly, the lights emitted by light sources of different colors have respective intensities corresponding to the color values of the datum. In one embodiment, the light sources 3502 are LED lamps, which may be welded on a control circuit 3504, such as a PCBA, and is driven by the control circuit 3504 to illuminate a light.

In one embodiment, the exits of the optical fibers 352 may be formed as a convex surface to function as a lens for condensing the lights transmitted through the optical fibers 352. Alternately, the exits of the optical fibers 352 may also be formed as a flat surface. For the purpose of light-condensing, the recording unit 35 may further include a plurality of lens 354, each of which is disposed in front of the exit of the corresponding optical fiber 352, for condensing the lights transmitted out of the optical fibers 352 from the exits.

Particularly, the optical fibers 352 may be arranged in an optical fiber cartridge 356 in accordance with the way that the red, green, and blue color fields constitute the pixel 12. In one embodiment, a guiding shaft 39 is disposed in the recording system 3 to mount the optical fiber cartridge 356 and enable the optical fiber cartridge 356 to move linearly along the guiding shaft 39. Actuated by devices like rollers, the light-sensitive sheet 1 is moved along a direction perpendicular to the guiding shaft 39. The recording unit 35 then sequentially records data onto the light-sensitive sheet 1.

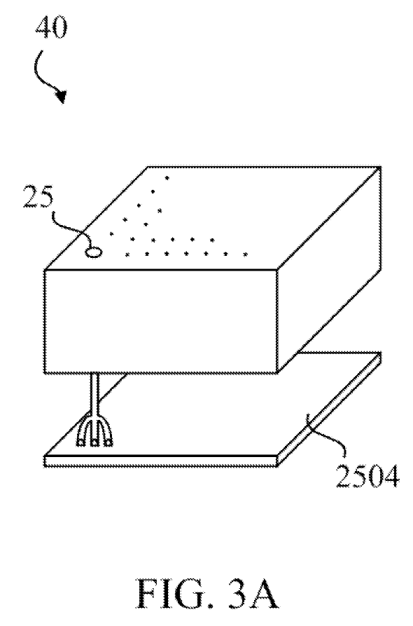

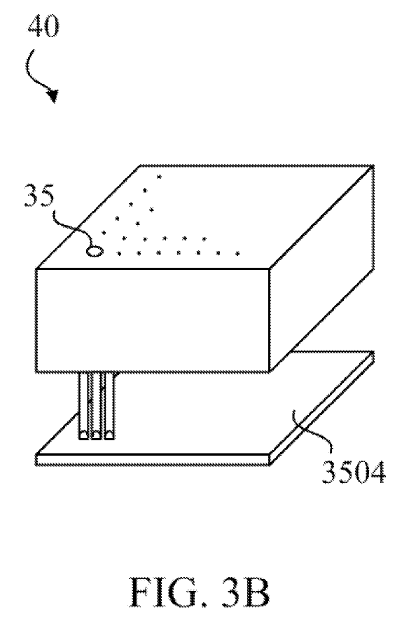

Please refer to FIGS. 3A and 3B, illustrating a recording head 40 which is configured to arrange a plurality of recording units according to the preferred embodiments of the invention. As shown in FIG. 3A, the recording head 40 is used for containing a plurality of recording units 25 in the recording system 2 according to the first preferred embodiment of the invention. As shown in FIG. 3B, the recording head 40 is used for containing a plurality of recording units 35 in the recording system 3 according to the second preferred embodiment of the invention. Each of the recording units is capable of recording a datum onto a pixel 12 of a light-sensitive sheet 1. By arranging the recording units into an array in the recording head 40, the recording system, according to the invention, may be extended to record data onto multiple pixels simultaneously.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for recording a datum onto a pixel on a light-sensitive sheet, said system comprising:
a controlling/processing unit for receiving and processing the datum, controlling, based on the datum, an actuating device, and driving, according to the datum, a light-emitting device;
a recording unit, disposed such that said recording unit faces a side of the sheet where the pixel is formed when the sheet is installed in said system, said recording unit comprising:
the light-emitting device, for emitting a light when driven by the controlling/processing unit; and
a light-guiding device having an entrance coupled to the light-emitting device and an exit, wherein the light, once emitted by the light-emitting device, enters the light-guiding device from the entrance, and is transmitted out from the exit; and
the actuating device, for movably carrying the recording unit, the actuating device being controlled by the controlling/processing unit to move the recording unit such that the exit of the light-guiding device of the recording unit is positioned at a position corresponding to the pixel on the sheet;
whereby the light transmitted out from the exit of the light-guiding device is further projected onto the pixel to record the datum on the pixel.

2. The system of claim 1, wherein the controlling/processing unit comprises:
a processor, for receiving and processing the datum;
a controller, operated by the processor, for controlling the actuating device based on the datum; and
a driver, operated by the processor, for driving the light-emitting device in accordance with the datum.

3. The system of claim 1, wherein the light-guiding device is flexible, the recording unit further comprises a cartridge, movably mounted in said system and operatively coupled to the actuating device, the light-emitting device is fixedly mounted in said system, the exit of the flexible light-guiding device is arranged in the cartridge, and the actuating device is driven to move the cartridge linearly.

4. The system of claim 3, further comprising a sheet-delivering device driven by the controlling/processing unit to move along a direction perpendicular to the linear movement of the cartridge on the basis of the datum.

5. The system of claim 4, wherein the flexible light-guiding device is an optical fiber.

6. The system of claim 1, wherein the pixel is constituted by N color fields, the datum comprises values of N colors which each corresponds to one of the N color fields, N is a natural number.

7. The system of claim 6, wherein the light consists of rays of the N colors, the light-emitting device comprises N light sources which each is driven, according to the datum, to emit one of the rays of the N colors.

8. The system of claim 7, wherein the N light sources are turned on successively.

9. The system of claim 8, wherein the entrance of the light-guiding device is coupled to the N light sources, respectively.

10. The system of claim 9, wherein the light-guiding device is an optical fiber.

11. The system of claim 10, wherein the exit of the optical fiber is formed as a convex surface for condensing the light transmitted through the optical fiber.

12. The system of claim 10, wherein said recording unit further comprises a lens, disposed in front of the exit of the optical fiber, for condensing the light transmitted out of the optical fiber from the exit.

13. The system of claim 6, wherein the light consists of rays of the N colors, the light-emitting device is driven, according to the datum, to emit the rays of the N colors, the light-guiding device comprises N light-guiding components which each corresponds to one of the rays of the N colors and has a respective sub-entrance coupled to the light-emitting device and a respective sub-exit, one of the rays of the N colors, once emitted by the light-emitting device, enters the sub-entrance of the corresponding light-guiding components, and is transmitted out from the sub-exit of the corresponding light-guiding component, and the actuating device is controlled to move the recording unit such that the sub-exit of one of the N light-guiding components of the recording unit is positioned at the position corresponding to the corresponding color field of the pixel on the sheet.

14. The system of claim 13, wherein the light-emitting device comprises a plurality of light sources, at least one of the light sources corresponds to one of the rays of the N colors and is driven, according to the datum, to emit the corresponding ray, the sub-entrance of each of the light-guiding component is coupled to the light sources corresponding to said one light-guiding component, respectively.

15. The system of claim 14, wherein the N light sources are turned on successively.

16. The system of claim 15, wherein each of the light-guiding components is an optical fiber.

17. The system of claim 16, wherein the sub-exit of each of the optical fibers is formed as a convex surface for condensing the ray transmitted through said one optical fiber.

18. The system of claim 16, wherein said recording unit further comprises N lenses, each of the N lenses corresponds to one of the optical fibers and is disposed in front of the sub-exit of the corresponding optical fiber, and functions condensing the ray transmitted out from the sub-exit of the corresponding optical fiber.

19. The system of claim 6, wherein the N color values comprise red, green and blue color values.

20. The system of claim 1, wherein the sheet is a color paper.
